(19) United States
(12) Patent Application Publication
(10) Pub. No.: US 2005/0083608 A1
(43) Pub. Date: Apr. 21, 2005

(54) Magnetic head

(75) Inventor: Toshinori Watanabe, Niigata-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/963,859

(22) Filed: Oct. 13, 2004

(30) Foreign Application Priority Data
Oct. 17, 2003 (JP) 2003-357251

(51) Int. Cl. G11B 5/147

(52) U.S. Cl. 360/126

(57) ABSTRACT

A magnetic head has a reading portion HR and a perpendicular magnetic recording head H1 formed thereon. A first coil layer is formed between the reading portion HR and one magnetic portion of a first magnetic portion and a second magnetic portion, the first magnetic portion and the second magnetic portion forming the perpendicular magnetic recording head H1. A second coil layer is formed between the above one magnetic portion and the other magnetic portion, and joined to form a helical coil layer around the above one magnetic portion.

This application claims the benefit of Japanese Patent Application No.: 2003-357251, filed on Oct. 17, 2003, which is incorporated herein by reference.

### TECHNICAL FIELD

The present application relates to perpendicular magnetic recording heads performing recording by applying a perpendicular magnetic field onto a recording medium such as a disc having a hard film, and more particularly, relates to a perpendicular magnetic recording head which may counteract a leakage recording magnetic field generated in an upper shield layer provided above a magnetoresistive effect element (MR element), suppress recording fringing, and increase the effective number of turns of a coil.

### BACKGROUND

In a perpendicular magnetic recording system in which a recording medium is magnetized in a direction perpendicular to a surface thereof, recording data can be recorded at a high density as compared to a system in which a recording medium is magnetized in a direction parallel to a surface thereof. FIG. 11 is a longitudinal cross-sectional view of a general structure of a perpendicular magnetic recording head used for a device in accordance with the perpendicular magnetic recording system described above. A perpendicular magnetic recording head H0 of the perpendicular magnetic recording system shown in FIG. 11 is provided on a side end surface of a slider which slides on a recording medium or travels above it while floating.

As shown in FIG. 11, on an upper surface 1b of a slider 1, a non-magnetic insulating layer 2 made of an inorganic material such as Al₂O₃ or SiO₂ is formed, and on this non-magnetic insulating layer 2, a reading portion HR is formed.

The reading portion HR is formed of a lower shield layer 3, a gap layer 4, a reading element 5, and an upper shield layer 6, in that order from the bottom. The reading element 5 uses the magnetoresistive effect, such as AMR, GMR, or TMR.

On the reading portion HR, an isolating layer 7 made of an inorganic material, such as Al₂O₃ or SiO₂, is formed, and on this isolating layer 7, a recording magnetic head H0 is provided.

In addition, a yoke layer 8 made of a ferromagnetic material is buried in the isolating layer 7.

On an upper surface of the yoke layer 8, a plating underlying film 9 is formed which is a conductive metal film made of NiFe or the like, and on this underlying film 9, a main magnetic pole 10 made of a ferromagnetic material is formed.

On the main magnetic pole 10, a gap layer 11 is formed using an inorganic material, and on this gap layer 11, a return path layer 12 is formed using a ferromagnetic material such as Permalloy.

In addition, at a rear side with respect to a facing surface H0a, a connection portion 12b of the return path layer 12, the main magnetic pole 10, and the yoke layer 8 are connected to each other.

An insulating material layer 19 is provided around the main magnetic pole 10.

A coil insulating underlayer 13 is formed around the connection portion 12b. On this coil insulating underlayer 13, a coil layer 14 made of a conductive material such as Cu is formed. This coil layer 14 is formed in a spiral (coil) shape by patterning so as to have a predetermined number of turns around the connection portion 12b. On a terminal end 14a of the coil layer 14 at the central side, a lifting layer 15 also made of a conductive material such as Cu is formed. The coil layer 14 and the lifting layer 15 are covered with a coil insulating layer 16.

In addition, an upper surface of the lifting layer 15 is exposed at the surface of the coil insulating layer 16 and is connected to a lead layer 17. Hence, a recording current can be supplied from the lead layer 17 to the coil layer 14 through the lifting layer 15.

The return path layer 12 and the lead layer 17 are covered with a protective layer 48 made of an inorganic non-magnetic insulating material or the like.

In addition, a Gd determining layer 18 is formed on the gap layer 11 at a position apart from the facing surface H0a facing a recording medium at a predetermined distance, and a gap depth length of the magnetic head H0 is defined by the distance from the facing surface H0a facing a recording medium to the front end of the Gd determining layer 18.

Since the connection portion 12b of the return path layer 12, the main magnetic pole 10, and the yoke layer 8 are connected to each other at the rear side with respect to the facing surface H0a, a magnetic path is formed connecting the return path layer 12, the main magnetic pole 10, and the yoke layer 8.

As a result, when a recording magnetic field is induced in the return path layer 12 and the yoke layer 8 through the main magnetic pole 10 by supplying electricity to the coil layer 14, a leakage recording magnetic field between a front end surface 12a of the return path 12 and a front end surface 10a of the main magnetic pole 10 is aligned in a direction perpendicular to the recording medium, and by a magnetic flux φ of this leakage recording magnetic field, magnetic data are recorded on the recording medium.

Recording thin film magnetic heads (inductive head) having a magnetic pole layer and a coil layer have been increasingly miniaturized, concomitant with the recent trend toward higher recording density, and hence a coil layer must be formed in a spiral shape in a very small space.

Accordingly, it has been believed that a thin film magnetic head having a helical structure which is formed by winding a coil layer in a helical manner around a magnetic pole layer used as a core will become a mainstream technique for an inductive head instead of a thin film magnetic head having a spiral coil structure which is formed by winding a coil layer around a connection portion for connecting a lower magnetic pole layer and a upper magnetic pole layer by the use of a space formed therebetween.

In Japanese Unexamined Patent Application Publication Nos. 2002-319109 and 2001-84518, a magnetic head has been disclosed in which a coil layer is wound around an upper magnetic pole layer used as a core, and in addition, a coil layer is also wound around a lower magnetic pole layer used as a core.

FIG. 12 shows a magnetic head having the structure equivalent to that shown in FIG. 30 of Japanese Unexamined Patent Application Publication No. 2002-319109 or to that shown in FIG. 2 of Japanese Unexamined Patent Application Publication No. 2001-84518.

Reference numeral 23 shown in FIG. 12 indicates a lower shield layer, reference numeral 24 indicates a gap layer, reference numeral 25 indicates a magnetoresistive effect element, and reference numeral 26 indicates an upper shield layer. In addition, on the upper shield layer 26, a first coil layer 28 is formed with a coil insulating underlayer 27 provided therebetween, and a coil insulating layer 29 is formed so as to cover this first coil layer 28. On the upper shield layer 26 and the coil insulating layer 29, a lower magnetic pole layer 31 is formed with an insulating layer 30 provided therebetween. On the lower magnetic pole layer 31, a second coil layer 33 is formed with a gap layer 32 provided therebetween, and furthermore, on this second coil layer 33, a third coil layer 35 is formed with an isolating layer 34 provided therebetween.

Furthermore, a coil insulating layer 36 is formed so as to cover the second coil layer 33, the isolating layer 34, and the third coil layer 35, and on this coil insulating layer 36, an upper magnetic pole layer 37 is formed. A rear end region of this upper magnetic pole layer 37 is connected to a rear end region of the lower magnetic pole layer 31. In addition, on the upper magnetic pole layer 37, a fourth coil layer 39 is formed with a coil insulating underlayer 38 provided therebetween.

In the magnetic head shown in FIG. 12, current flows through the first coil layer 28 in the direction opposite to an X direction in the figure, and current flows through the second coil layer 33 in the X direction in the figure. In addition, current flows through the third coil layer 35 in the X direction in the figure, and current flows through the fourth coil layer 39 in the direction opposite to the X direction in the figure.

Hence, as shown in FIG. 12, in accordance with the “right-hand rule”, a magnetic field in a clockwise direction is generated around the first coil layer 28, and a magnetic field in an anticlockwise direction is generated around the second coil layer 33. Accordingly, in the lower magnetic pole layer 31 located between the first coil layer 28 and the second coil layer 33, a magnetic flux φa is generated which flows in a Y direction in the figure as shown in FIG. 12. On the other hand, a magnetic field in an anticlockwise direction is generated around the third coil layer 35, and a magnetic field in a clockwise direction is generated around the fourth coil layer 39. Accordingly, in the upper magnetic pole layer 37 located between the third coil layer 35 and the fourth coil layer 39, a magnetic flux φb is generated which flows in the direction opposite to the Y direction in the figure as shown in FIG. 12.

As described above, the lower magnetic pole layer 31 and the upper magnetic pole layer 37 are connected to each other at the individual rear end regions. Hence, the magnetic flux of the magnetic field, which is generated in the lower magnetic pole layer 31 and flows in the Y direction in the figure, flows into the upper magnetic pole layer 37 through the rear end region of the lower magnetic pole layer 31 and then further flows in the direction opposite to the Y direction in the figure. Since this magnetic flux flows in the same direction as that of the magnetic flux of the magnetic field generated in the upper magnetic pole layer 37, the above magnetic fluxes of the two magnetic fields join with each other, and a magnetic flux of a recording magnetic field is applied to a recording medium from a facing surface 37a facing the recording medium of the upper magnetic pole layer 37, so that recording data are recorded on the recording medium by a magnetic flux φ of this recording magnetic field. Subsequently, the magnetic flux φ passing through the recording medium returns to the lower magnetic pole layer 31.

In the process described above, since the magnetic flux φ also inevitably flows into the upper shield layer 26, and as a result, in the upper shield layer 26, a magnetic flux φm of a leakage magnetic field, which flows in the Y direction in the figure, is generated as indicated by a chain line in the figure. This type of phenomenon causes recording fringing and is not a preferable phenomenon. However, in the magnetic head shown in FIG. 12, the magnetic field in a clockwise direction is generated around the first coil layer 28, and hence in the upper shield layer 26, a magnetic flux φc is generated flowing in the direction opposite to the Y direction in the figure (that is, in the upper shield layer 26, the magnetic flux φc is generated in the direction opposite to that of the magnetic flux φm of the leakage magnetic field). Accordingly, the magnetic flux φm of the leakage magnetic field, which flows into the upper shield layer 26, is counteracted by the magnetic field φc generated in the upper shield layer 26. As a result, the flow of the magnetic flux φm of the leakage magnetic field through the upper shield layer 26 can be suppressed, and hence the recording fringing can be reduced.

However, in the perpendicular magnetic recording head H0 shown in FIG. 11, although the magnetic flux φ of the recording magnetic field described above flows through the upper shield layer 6 to generate a leakage magnetic field, since a magnetic flux which counteracts the magnetic flux of this leakage magnetic field is not present in the upper shield layer 6, a magnetic flux of the leakage magnetic field flowing through the upper shield layer 6 cannot be suppressed. Hence, there has been a problem in that the recording fringing is generated by this leakage magnetic field.

On the other hand, in the magnetic head shown in FIG. 12, by counteracting the magnetic flux φm of the leakage magnetic field, which flows through the upper shield layer 26, with the magnetic flux φc generated in the upper shield layer 26, the recording fringing can be suppressed.

However, in the magnetic head shown in FIG. 12, the magnetic flux φa generated in the lower magnetic pole layer 31 is caused by the two coil layers, that is, the first coil layer 28 and the second coil layer 33. As is the case described above, the magnetic flux φb generated in the upper magnetic pole layer 37 is caused by the two coil layers, that is, the third coil layer 35 and the fourth coil layer 39.

That is, in the magnetic head shown in FIG. 12, the magnetic flux φ of the recording magnetic field is generated by the four coil layers from the first to the fourth coil layers 28, 33, 35, and 39. Hence, the magnetic flux φ of the recording magnetic field is very large. Accordingly, the magnetic flux φm of the leakage magnetic field flowing into the upper shield layer 26 is very large.

However, as shown in FIG. 12, the magnetic flux φc generated in the upper shield layer 26 is only caused by the first coil layer 28, and hence it is believed that the magnetic flux φc may be smaller than the magnetic flux φm in many cases. Accordingly, the magnetic flux φm of the leakage magnetic field, cannot be sufficiently counteracted by the magnetic flux φc generated in the upper shield layer 26, and as a result, there has been a problem in that the recording fringing cannot be effectively suppressed.

### SUMMARY

A magnetic head comprises a reading portion having a reading element and a perpendicular magnetic recording head formed on the reading portion. The perpendicular magnetic recording head comprises a first magnetic portion which has a main magnetic pole formed to have a track width at a surface facing a recording medium and a second magnetic portion having a width dimension larger than the track width, the first magnetic portion and the second magnetic portion being disposed one over the other with a space therebetween at a position above the reading portion, the first magnetic portion and the second magnetic portion being in direct or indirect contact with each other at a position apart from the surface facing a recording medium in a height direction. A first coil layer is formed between the reading portion and one magnetic portion of the first magnetic portion and the second magnetic portion, whichever is closer to the reading portion. A second coil layer is formed between said one magnetic portion and the other magnetic portion disposed above said one magnetic portion, and the first coil layer and the second coil layer are electrically connected to each other so as to form a helical coil layer wound around said one magnetic portion.

The first coil layer may be formed to have a cross-sectional area larger than that of the second coil layer. In this case, the structure is preferably formed in which the first coil layer has a width dimension in the height direction larger than that of the second coil layer.

In addition, the structure may be formed in which the helical coil layer applies a recording magnetic field to said one magnetic portion located closer to the reading portion, a magnetic path is formed in which a magnetic flux of the recording magnetic field flows through the first magnetic portion and the second magnetic portion, and a magnetic flux is generated around the first coil layer in a direction opposite to that of a magnetic flux, which flows through the reading portion, of a leakage magnetic field from the recording magnetic field. Accordingly, the magnetic flux of the leakage magnetic field is counteracted by the magnetic flux in the direction opposite thereto.

Said one magnetic portion located closer to the reading portion may be the first magnetic portion, or said one magnetic portion located closer to the reading portion may be the second magnetic portion.

The recording magnetic field is generated by the first coil layer formed between the reading portion and said one magnetic portion located closer thereto and the second coil layer formed between the other magnetic portion and said one magnetic portion located closer to the reading portion.

In the case in which the leakage magnetic field is generated when a magnetic flux of the recording magnetic field flows into the reading portion, a magnetic flux can be generated which flows in a direction so as to counteract the leakage magnetic field generated in the reading portion. The magnetic field for counteracting the leakage magnetic field is generated by the first coil layer.

Hence, with respect to the intensity of the magnetic flux of the leakage magnetic field, the intensity of the magnetic flux for counteracting the above leakage magnetic flux is not excessively small, and intensity unbalance between the two magnetic fluxes is not significant; hence, the magnetic flux of the leakage magnetic field can be effectively counteracted. As a result, the recording fringing may be effectively suppressed.

By effectively counteracting the magnetic flux of the leakage magnetic field of the upper shield layer, without increasing a coil resistance, in addition to an increase of the effective number of turns of the coil layer, the magnetic stability of the reading element provided in the reading portion may also be improved.

The recording magnetic field can be generated by the two coil layers, and the magnetic flux of the leakage magnetic field can be counteracted; hence, the whole magnetic head may be miniaturized.

When the cross-sectional area of the first coil layer is formed larger than that of the second coil layer so as to have the structure in which the width dimension of the first coil layer in the height direction is larger than the width dimension of the second coil layer in the height direction, the resistance of the helical coil layer may be decreased, and the generation of heat of the magnetic head may be suppressed. Hence, a so-called PTP (Pole Tip Protrusion) phenomenon in which, due to the difference in coefficient of thermal expansion among constituent elements forming the magnetic head, and a portion of the magnetic head protrudes from the surface facing a recording medium, may be suppressed.

Said one magnetic portion located closer to the reading portion may be the first magnetic portion, or said one magnetic portion located closer to the reading portion may be the second magnetic portion.

The magnetic flux of the recording magnetic field can be generated by the two coil layers (the first coil layer and the second coil layer), and the magnetic flux of the leakage magnetic field which is caused by the magnetic flux of the recording magnetic field generated by the two coil layers is counteracted by the magnetic flux (magnetic flux in the direction opposite to that of the magnetic flux of the leakage magnetic field) generated by one coil layer (the first coil layer). Hence, the intensity unbalance between the magnetic flux of the leakage magnetic field and the magnetic flux for the counteraction is not significant, and as a result, the magnetic flux of the leakage magnetic field may be counteracted. Accordingly, the recording fringing may be suppressed.

By counteracting the magnetic flux of the leakage magnetic field of the reading portion, without increasing the coil resistance, the effective number of turns of the coil layer may be increased, and the magnetic stability of the reading element provided in the reading portion may also be improved.

The recording magnetic field can be generated by only the two coil layers, and the magnetic flux of the leakage magnetic field may be counteracted; hence, the whole magnetic head may be miniaturized.

### BRIEF DESCRIPTION OF THE DRAWINGS

FIG. 1 is a longitudinal cross-sectional view of a magnetic head of a first embodiment;

FIG. 2 is a front view of the magnetic head shown in FIG. 1;

FIG. 3 is a partial plan view of the magnetic head shown in FIG. 1;

FIG. 4 is a schematic view of the magnetic head shown in FIG. 1;

FIG. 5 is a longitudinal cross-sectional view of a magnetic head of a second embodiment;

FIG. 6 is a partial perspective view of the magnetic head shown in FIG. 5;

FIG. 7 is a partial plan view of the magnetic head shown in FIG. 5;

FIG. 8 is a schematic view of the magnetic head shown in FIG. 5;

FIG. 9 is a longitudinal cross-sectional view of a magnetic head of a third embodiment;

FIG. 10 is a longitudinal cross-sectional view of a magnetic head of a fourth;

FIG. 11 is a longitudinal cross-sectional view of a related magnetic head; and

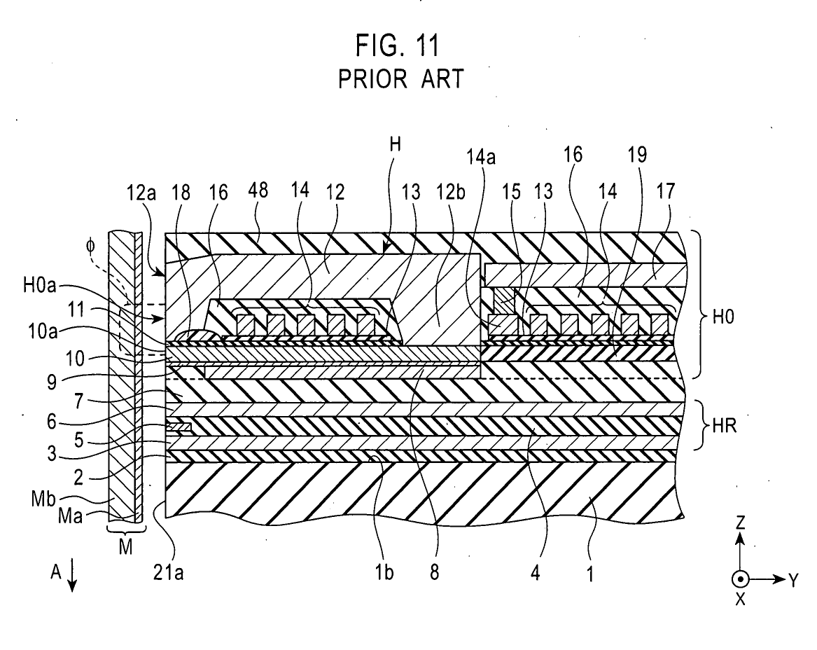

FIG. 12 is a schematic view of a related magnetic head.

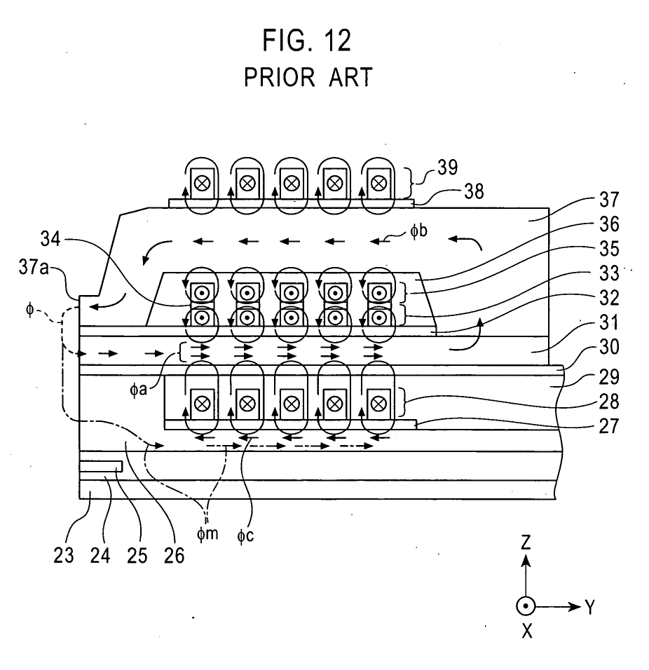

### DETAILED DESCRIPTION

Exemplary embodiments of the invention may be better understood with reference to the drawings, but these embodiments are not intended to be of a limiting nature. Rather, the invention is to cover all modifications, equivalents, and alternatives falling within the spirit and scope of the invention which is set forth by the claims.

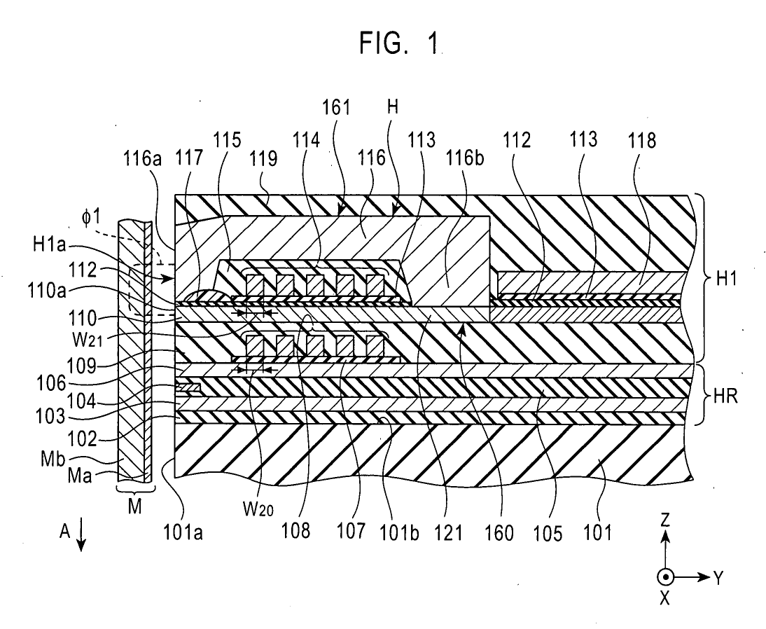

FIG. 1 is a longitudinal cross-sectional view showing a magnetic head according to a first embodiment. A magnetic head H1 shown in FIG. 1 is a so-called perpendicular magnetic recording head in which a perpendicular magnetic field is applied to a recording medium M so as to magnetize a hard film Ma of the recording medium M in a direction perpendicular thereto.

The recording medium M is, for example, in the form of a disc composed of the hard film Ma, which has a high residual magnetization and which is provided at a surface side, and a soft film Mb, which has a high magnetic transmittance and which is provided at an inner side, and the recording medium M is to be rotated on its axis which is the center point of the disc.

A slider 101 is formed of a non-magnetic material such as Al₂O₃.TiC, and a surface 101a of the slider 101 faces the recording medium M. When the recording medium M rotates, the slider 101 floats from a surface of the recording medium M by airflow along the surface thereof or slides thereon. In FIG. 1, the traveling direction of the recording medium M with respect to the slider 101 is an A direction.

At an end surface 101b of the slider 101 at a trailing side, a non-magnetic insulating layer 102 made of an inorganic material, such as Al₂O₃ or SiO₂, is formed, and on this non-magnetic insulating layer 102, a reading portion HR is formed.

The reading portion HR has a lower shield layer 103, an upper shield layer 106, and a reading element 104 located inside an inorganic insulating layer (gap insulating layer) 105 provided between the lower shield layer 103 and the upper shield layer 106. The reading element 104 is a magnetoresistive effect element such as AMR, GMR, or TMR.

On the upper shield layer 106, a plurality of first coil layers 108 made of a conductive material is provided with a coil insulating underlayer 107 provided therebetween. The first coil layers 108 are each formed, for example, of at least one non-magnetic metal material selected from the group consisting of Au, Ag, Pt, Cu, Cr, Al, Ti, NiP, Mo, Pd, and Rh. Alternatively, a laminate structure composed of the non-magnetic metal materials mentioned above may be formed.

Around the first coil layers 108, a coil insulating layer 109 made of an inorganic material such as Al₂O₃ is formed.

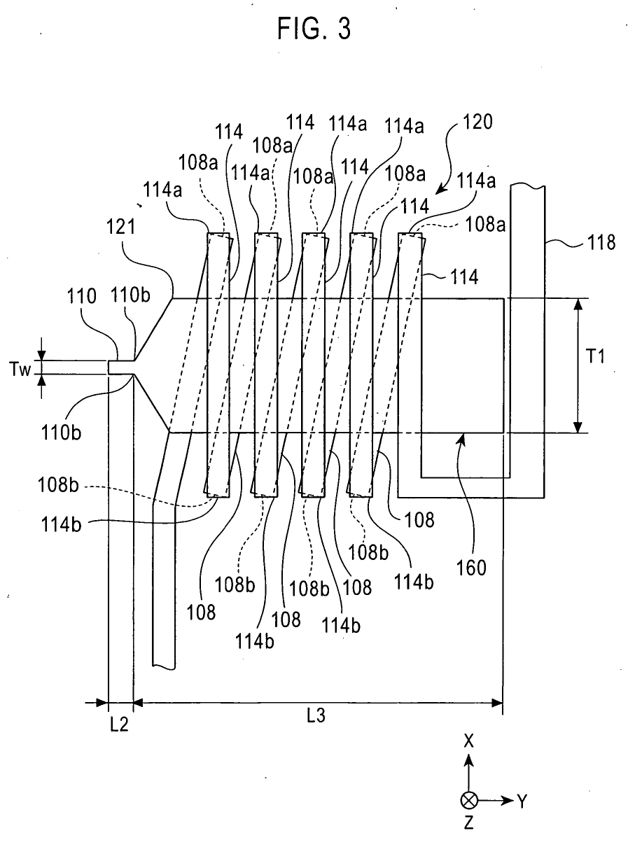

An upper surface 109a of the coil insulating layer 109 is planarized, and on this upper surface 109a, a main magnetic pole 110 is formed having a predetermined length L2 (see FIG. 3) from a facing surface H₁a in a height direction and a width dimension in a track width direction (X direction in the figure) formed equivalent to a track width Tw. The main magnetic pole 110 is formed, for example, by plating using a ferromagnetic material, and a material having a high saturated magnetic flux density, such as Ni—Fe, Co—Fe, or Ni—Fe—Co, is used.

In addition, a yoke portion 121 is integrally formed from a base end portion 110b of the main magnetic pole 110 to extend in a height direction (Y direction in the figure) while a width dimension T1 of the yoke portion 121 in the track width direction increases larger than the track width Tw. This main magnetic pole 110 and the yoke portion 121 collectively form a first magnetic portion 160 (see FIG. 3). However, the main magnetic pole 110 and the yoke portion 121 may be formed separately from each other. In the magnetic head H1 shown in FIG. 1, the first magnetic portion 160 formed of the main magnetic pole 110 and the yoke portion 121 is a magnetic portion located at the reading portion side.

The track width Tw described above may formed in the range of from 0.1 to 1.0 μm, and the length L2 may be formed in the range of from 0;1 to 1.0 μM.

The largest width dimension of the yoke portion 121 in the track width direction (X direction in the figure) may be in the range of approximately 1 to 100 μm, and a length L3 of the yoke portion 121 in the height direction may be in the range of approximately 1 to 100 μm.

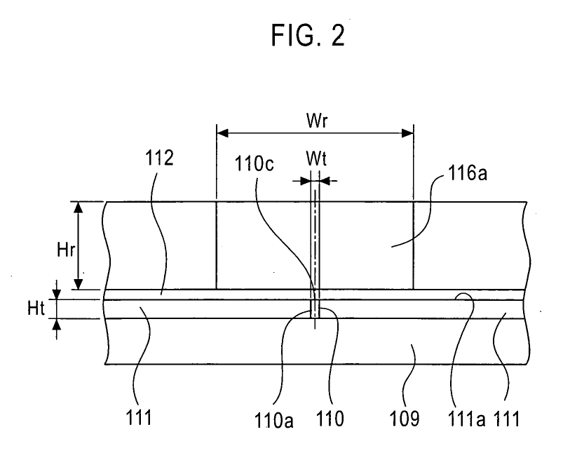

FIG. 2 is a front view of the magnetic head H1 shown in FIG. 1. FIG. 1 is a cross-sectional view of the magnetic head taken along the chain line shown in FIG. 2, the magnetic head being viewed from the recording medium.

As shown in FIG. 2, the main magnetic pole 110 exposed at the surface H1a facing the recording medium is formed so that the width dimension in the track width direction (X direction) is Wt. Although not shown in the figure, the track width dimension of the yoke portion 121 is formed larger than the width dimension Wt of the main magnetic pole 110 in the track width direction (see FIG. 3).

As shown in FIG. 2, an insulating material layer 111 is provided around the main magnetic pole 110. An upper surface 110c of the main magnetic pole 110 and an upper surface 111a of the insulating material layer 111 formed around the main magnetic pole 110 are flush with each other. The insulating material layer 111 may be formed, for example, of at least one of alumina (Al₂O₃), SiO₂, Al—Si—O, Ti, W, and Cr.

A gap layer 112 which is made of an inorganic material such as alumina (Al₂O₃) or SiO₂ is provided on the main magnetic pole 110, the yoke portion 121 and on the insulating material layer 111.

As shown in FIG. 1, on the gap layer 112, second coil layers 114 are formed with a coil insulating underlayer 113 provided therebetween. As with the first coil layers 108, the second coil layers may be a plurality of layers formed of a conductive material. The second coil layers 114 are each formed of, for example, at least one non-magnetic metal material selected from the group consisting of Au, Ag, Pt, Cu, Cr. Al, Ti, NiP, Mo, Pd, and Rh. Alternatively, a laminate structure composed of the non-magnetic metal materials mentioned above may be formed.

As shown in FIG. 3, the first coil layers 108 and the second coil layers 114 are electrically connected to each other between respective terminal portions 108a and 114a and between respective terminal portions 108b and 114b, which are located in the track width direction (X direction in the figure). Hence, the first coil layers 108 and the second coil layers 114 form a helical coil layer 120 which is wound around the main magnetic pole 110 and yoke portion 121 used as a core.

As shown in FIG. 1, a width dimension W20 of the first coil layer 108 in the height direction (Y direction in the figure) and a width dimension W21 of the second coil layer 114 in the height dimension (Y direction in the figure) are formed substantially equivalent to each other.

A coil insulating layer 115 is formed around the second coil layers 114, using an inorganic insulating material such as Al₂O₃, and a return path layer 116, which is a second magnetic portion 161, is formed continuously on the gap layer 112, the coil insulating layer 115, and the yoke portion 121 using a ferromagnetic material such as Permalloy.

As shown in FIG. 2, a thickness Ht of a front end surface 110a of the main magnetic pole 110 is smaller than a thickness Hr of a front end surface 116a of the return path 116, and the width dimension Wt of the front end surface 110a of the main magnetic pole 110 in the track width direction (X direction in the figure) is sufficiently smaller than a width dimension Wr of the front end surface 116a of the return path layer 116 in the same direction. As a result, at the facing surface H1a, the area of the front end surface 11a of the main magnetic pole 110 is sufficiently smaller than that of the front end surface 116a of the return path layer 116. Hence, a magnetic flux φ of a leakage recording magnetic field is concentrated on the front end surface 110a of the main magnetic pole 110, and the hard film Ma is magnetized in a perpendicular direction by this concentrated magnetic flux φ, so that magnetic data are recorded.

The front end surface 116a of the return path layer 116 is exposed at the surface H1a facing a recording medium. In addition, at the rear side from the facing surface H1a, a connection portion 116b of the return path layer 116 and the main magnetic pole 110 are connected to each other with the yoke portion 121 provided therebetween. Accordingly, a magnetic path connecting the main magnetic pole 110 and the return path layer 116 is formed.

A Gd determining layer 117 is formed using an inorganic or an organic material on the gap layer 112 at a position displaced at a predetermined distance from the surface H1a facing a recording medium. A gap depth length of the magnetic head H1 is defined by the distance from the surface H1a facing a recording medium to a front end of the Gd determining layer 111. In the height direction (Y direction in the figure) side of the connection portion 116b of the return path layer 116, a lead layer 118 extending from the second coil layer 114 is formed on the coil insulating underlayer 113. The return path layer 116 and the lead layer 118 are covered with a protective layer 119 formed of an inorganic non-magnetic insulating material or the like.

In the magnetic head H1 described above, when a recording current is supplied to the first coil layers 108 and the second coil layers 114 through the lead layer 118, due to a current magnetic field caused by the current flowing through the first coil layers 108 and the second coil layers 114, a recording magnetic field is induced in the main magnetic pole 110 and the return path layer 116, and a magnetic flux φ1 of the recording magnetic field is applied from the front end surface 110a of the main magnetic pole 110 at the facing surface H1a to the recording medium M. After the magnetic flux φ1 of this magnetic field penetrates through the hard film Ma of the recording medium M and flows through the soft film Mb so that recording signals are recorded on the recording medium M, the magnetic flux φ1 returns to the front end surface 116a of the return path layer 116.

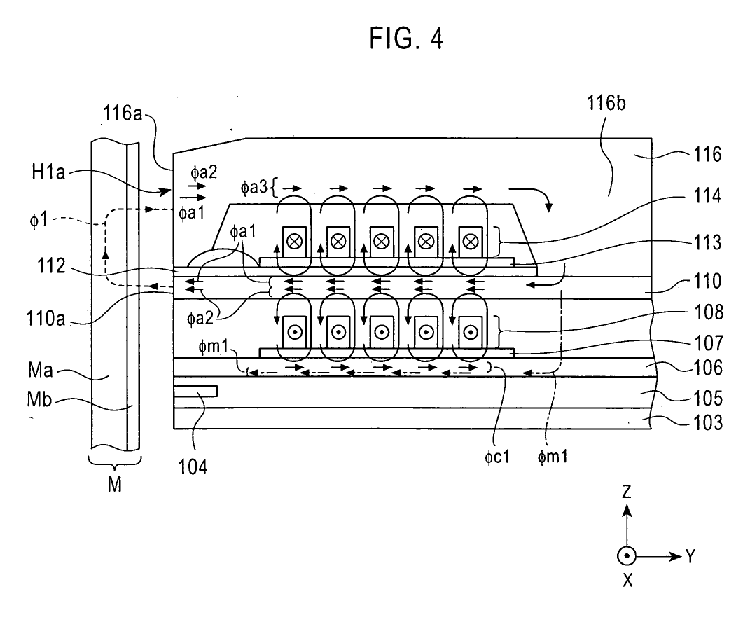

FIG. 4 is a view schematically showing the generation of the magnetic fields. A current along the X direction in the figure flows in the first coil layers 108, and in the second coil layers 114, a current flows along the direction opposite to the X direction in the figure.

In accordance with the “right-hand rule”, a magnetic field in an anticlockwise direction is generated around the first coil layers 108, and a magnetic field in a clockwise direction is generated around the second coil layers 114. In the main magnetic pole 110 and the return path layer 116 located between the first coil layers 108 and the second coil layers 114, a magnetic flux φa2 flowing in the direction opposite to the Y direction in the figure is generated by the first coil layers 108. At the same time, a magnetic flux φa1 flowing in the direction opposite to the Y direction in the figure is generated by the second coil layers 114.

In the return path layer 116, a magnetic flux φa3 flowing in the Y direction in the figure is generated by a magnetic field in a clockwise direction around the second coil layers 114.

After the magnetic fluxes φa1 and φa2, which are generated in the main magnetic pole 110 and the yoke portion 121 to flow in the direction opposite to the Y direction in the figure, are applied from the front end surface 110a of the main magnetic pole 110 at the surface H1a facing the recording medium M, the magnetic fluxes described above penetrate the hard film Ma of the recording medium M and then flow through the soft film Mb. In this process, recording signals are recorded on the recording medium M. Subsequently, the magnetic fluxes φa1 and φa2 flow into the return path layer 116 through the front end surface 116a thereof and flow in the Y direction in the figure.

In addition, the magnetic flux φa3 flowing in the Y direction in the figure is generated in the return path layer 116, and the magnetic fluxes φa1 and φa2 flowing into the return path layer 116 also flow in the Y direction in the figure together with the magnetic flux φa3.

As described above, the main magnetic pole 110 and the connection portion 116b of the return path layer 116 are connected to each other. Hence, the magnetic fluxes φa1, φa2, and φa3 which pass through the return path layer 116 flow into the main magnetic pole 110 through the connection portion 116b of the return path layer 116 and flow in the direction opposite to the Y direction in the figure.

After being applied from the front end surface 110a of the main magnetic pole 110 at the surface H1a facing the recording medium M, the magnetic flux φ1, which is composed of the magnetic fluxes φa1, φa2, and φa3, penetrates the hard film Ma and then flows through the soft film Mb, so that recording signals are recorded on the recording medium M. The magnetic flux φ1 flowing through the soft film Mb again flows into the return path layer 116 from the front end surface 116a thereof and further passes along the Y direction in the figure.

In the process described above, when flowing from the connection portion 116b of the return path layer 116 into the main magnetic pole 110, the magnetic flux φ1 also inevitably flows into the upper shield layer 106 as shown by a chain line shown in FIG. 4, and as a result, a magnetic flux φm1 of a leakage magnetic field shown by a chain line is generated which flows in the direction opposite to the Y direction in the figure. When being applied to the recording medium M from a front end surface 106a of the upper shield layer 106, this magnetic flux φm1 may cause recording fringing, and recording properties may disadvantageously degraded.

However, in the magnetic head H1, the magnetic field in an anticlockwise direction is generated around the first coil layers 108, and hence in the upper shield layer 106, a magnetic flux φc1 of the magnetic field is generated to flow in the Y direction. That is, in the upper shield layer 106, the magnetic field φm1 of the leakage magnetic field and the magnetic flux φc1 of the magnetic field in the direction opposite thereto are both generated. Accordingly, the magnetic flux φm1 of the leakage magnetic field, which flows through the upper shield layer 106, is counteracted by the magnetic flux φc1 generated in the upper shield layer 106. As a result, the flow of the magnetic flux φm1 of the leakage magnetic field through the upper shield layer 106 may be suppressed, and hence the recording fringing may be reduced.

As shown in FIG. 4, in the magnetic head H1 described above, the magnetic fluxes φa1 and φa2 generated in the main magnetic pole 110 are generated by the two coil layers, that is, the first coil layers 108 and the second coil layers 114. On the other hand, the magnetic flux φa3 generated in the return path layer 116 is caused by one coil layer, that is, the second coil layers 114.

That is, in the magnetic head of the present invention, the magnetic flux φm1 of the leakage magnetic field, which is caused by the magnetic flux φ1 of the recording magnetic field generated by the two coil layers 108 and 114, is counteracted by the magnetic flux φc1 generated by one coil layer (first coil layers 108).

According to the structure of the magnetic head H1 of the present invention, the magnetic flux φ1 of the recording magnetic field is generated by only two coil layers (the first coil layers 108 and the second coil layers 114), and the magnetic flux φm1 of the leakage magnetic field caused by the magnetic flux φ1 of the recording magnetic field generated by the two coil layers (the first coil layers 108 and the second coil layers 114) is counteracted by the magnetic flux φc1 generated by one coil layer (the first coil layers 108). Accordingly, the intensity unbalance between the magnetic flux φm1 of the leakage magnetic field and the magnetic flux φc1 is not significant, and as a result, the magnetic flux φm1 of the leakage magnetic field may be effectively counteracted.

In addition, by counteracting the magnetic flux φm1 of the leakage magnetic field in the upper shield layer 106, without increasing a coil resistance, the effective number of turns of the coil layer may be increased, and at the same time, the magnetic stability of the reading element 104 provided under the upper shield layer 106 may also be improved.

Furthermore, since the magnetic flux φm1 of the leakage magnetic field can be effectively counteracted by the two coil layers, that is, the coil layers 108 and 114, the whole magnetic head can be miniaturized.

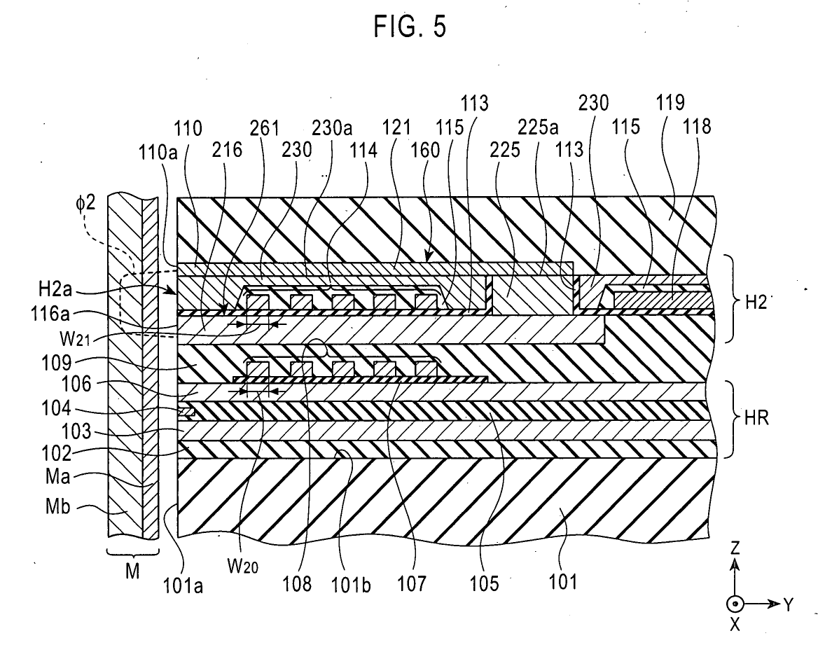

FIG. 5 is a longitudinal cross-sectional view of a magnetic head of a second embodiment. A magnetic head H2 shown in FIG. 5 is also a so-called perpendicular magnetic recording head in which a perpendicular magnetic field is applied to the recording medium M so that the hard film Ma thereof is magnetized in a direction perpendicular thereto.

Since the magnetic head H2 shown in FIG. 5 has the same constituent elements as those of the magnetic head H1 shown in FIG. 1, the same reference numerals of the magnetic head H1 shown in FIG. 1 designate the same constituent elements of the magnetic head H2 shown in FIG. 5, and descriptions thereof in detail will be omitted.

As shown in FIG. 5, the reading portion HR is formed on the non-magnetic insulating layer 102 provided on the end surface 101b of the slider 101 at the trailing side.

The recording magnetic head H2 is provided on the reading portion HR which is formed of the lower shield layer 103, the upper shield layer 106, and the reading element 104 located inside the inorganic insulating layer (gap insulating layer) 105 provided between the lower shield layer 103 and the upper shield layer 106. A surface H2a facing a recording medium of the magnetic head H2 is approximately flush with the facing surface 101a of the slider 101.

Alternatively, only the perpendicular magnetic recording head H2 may be mounted on the trailing side end portion of the slider 101 without providing the reading portion HR.

A plurality of the first coil layers 108 is formed on the upper shield layer 106, using a conductive material with the coil insulating underlayer 107 provided therebetween, and the coil insulating layer 109 is formed around the first coil layers 108.

On the upper surface 109a of the coil insulating layer 109, a return path layer 216 is formed from the facing surface H2a in the height direction. This return path layer 216 is a second magnetic portion and is formed of a ferromagnetic material such as Permalloy. In the magnetic head H2 shown in FIG. 5, this second magnetic portion 261 formed of this return path layer 216 is a magnetic portion located at the reading portion side.

On the upper surface of the return path layer 216 at a position in the height direction (Y direction in the figure), a connection layer 225 made of Ni—Fe or the like is formed.

On the return path layer 216, the coil insulating underlayer 113 is formed, and on this coil insulating underlayer 113, the second coil layers 114 are formed.

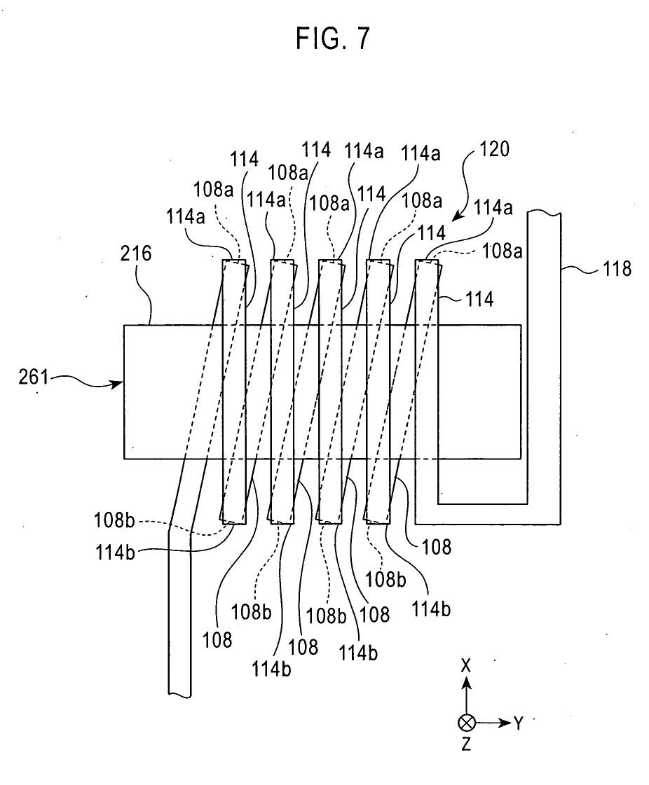

As shown in FIG. 7, the first coil layers 108 and the second coil layers 114 are electrically connected to each other between respective terminal portions 108a and 114a and between respective terminal portions 108b and 114b, which are located in the track width direction (X direction in the figure). Hence, the first coil layers 108 and the second coil layers 114 form the helical coil layer 120 which is wound around the return path layer 216 used as a core.

As shown in FIG. 5, the width dimension W20 of the first coil layer 108 in the height direction (Y direction in the figure) and the width dimension W21 of the second coil layer 114 in the height direction (Y direction in the figure) are formed equivalent to each other.

Around the second coil layers 114, the coil insulating layer 115 is formed, and an insulating layer 230 is formed. The insulating layer 230 is preferably formed of an inorganic insulating material, and as the inorganic insulating material, at least one material selected from the group consisting of AlO, Al₂O₃, SiO₂, Ta₂O₅, TiO, AlN, AlSiN, TiN, SiN, Si₃N₄, NiO, WO, WO₃, BN, CrN, and SiON may be selected. An upper surface 230a of this insulating layer 230 is processed to have a planarized surface. The planarization process mentioned above may be performed using a CMP technique or the like.

On the upper surface 230a of the insulating layer 230 described above, the main magnetic pole 110 and the yoke portion 121 are formed. The main magnetic pole 110 and the yoke portion 121 form the first magnetic portion 160. However, the main magnetic pole 110 and the yoke portion 121 may be separately formed.

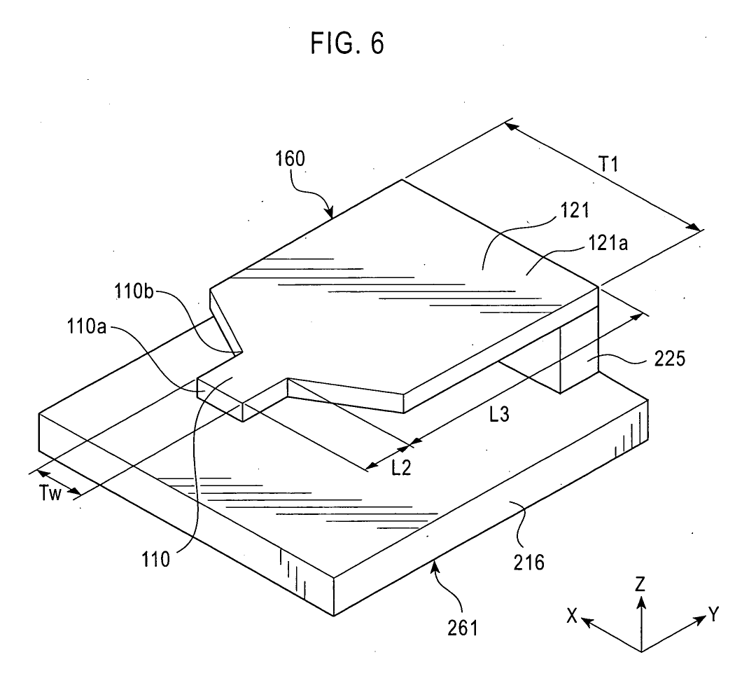

FIG. 6 is a partial perspective view schematically showing the return path layer 216, the connection layer 225, and the main magnetic pole 110 of the magnetic head H2 shown in FIG. 5. The main magnetic pole 110 extends a predetermined length from the front end surface 110a flush with the facing surface H2a in the height direction (Y direction in the figure) while the width dimension in the track width direction (X direction in the figure) is defined as the track width Tw. In particular, the track width Tw may be formed in the range of from 0.1 to 1.0 μm, and the length L2 may be formed in the range of from 0.1 to 1.0 μm.

As shown in FIG. 6, the yoke portion 121 may integrally formed from the base end portion 110b of the main magnetic pole 110 to extend in the height direction (Y direction in the figure) while the width dimension T1 of the yoke portion 121 in the track width direction increases so that it is larger than the track width Tw. In addition, the largest width dimension of the yoke portion 121 in the track width direction (X direction in the figure) may be in the range of approximately 1 to 100 μm, and the length L3 of the yoke portion 121 in the height direction is in the range of approximately 1 to 100 μm.

As shown in FIGS. 5 and 6, a base end portion 121a of the yoke portion 121 is formed on the connection layer 225, and hence the yoke portion 121 and an upper surface 225a of the connection layer 225 are magnetically connected to each other. As a result, a magnetic circuit connecting the main magnetic pole 110, the yoke layer 121, the connection layer 225, and the return path layer 216 is formed.

In the height direction (Y direction in the figure) of the connection layer 225, the lead layer 118 extending from the second coil layer 114 is formed on the coil insulating underlayer 113. On this lead layer 118, the coil insulating layer 115 and the insulating layer 230 are formed, and the main magnetic pole 110 and the insulating layer 230 are covered with the protective layer 119 made of an inorganic non-magnetic insulating material or the like.

In the magnetic head H2 described above, when a recording current is supplied to the first coil layers 108 and the second coil layers 114 through the lead layer 118, due to a current magnetic field caused by the current flowing through the first coil layers 108 and the second coil layers 114, a recording magnetic field is induced in the main magnetic pole 110 and the return path layer 216, and a magnetic flux φ2 of the recording magnetic field is applied from the front end surface 110a of the main magnetic pole 110 to the recording medium M at the facing surface H2a. After the magnetic flux φ2 of this recording magnetic field penetrates through the hard film Ma and flows through the soft film Mb so that recording signals are recorded on the recording medium M, the magnetic flux φ2 returns to a front end surface 216a of the return path layer 216.

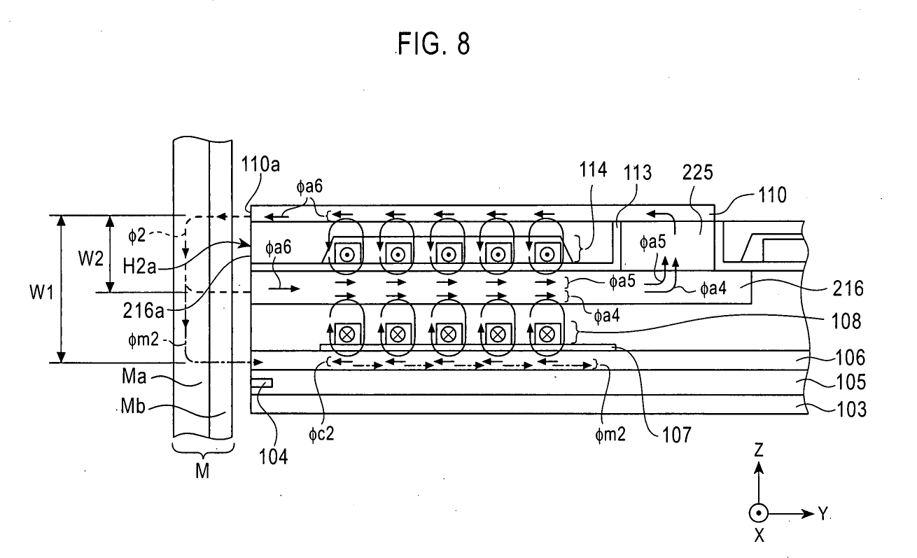

FIG. 8 is a schematic view showing the generation of the magnetic fields. In the magnetic head H2, a current flows in the first coil layers 108 in the direction opposite to the X direction in the figure, and in the second coil layers 114, a current flows in the X direction in the figure.

In accordance with the “right-hand rule”, a magnetic field in a clockwise direction is generated around the first coil layers 108, and a magnetic field in an anticlockwise direction is generated around the second coil layers 114. Thus, in the return path layer 216 located between the first coil layers 108 and the second coil layers 114, a magnetic flux φa4 flowing in the Y direction in the figure is generated by the first coil layers 108, and at the same time, a magnetic flux φa5 flowing in the Y direction in the figure is generated by the second coil layers 114.

In the main magnetic pole 110 and the yoke portion 121, a magnetic flux φa6 is generated flowing in the direction opposite to the Y direction by the magnetic field generated an anticlockwise direction around the second coil layer 114.

The magnetic flux φa6 flowing in the direction opposite to the Y direction in the figure, which is generated in the main magnetic pole 110 and the yoke portion 121, is applied to the recording medium M from the front end surface 110a of the main magnetic pole 110 at the facing surface H2a, the magnetic flux φa6 penetrates the hard film Ma of the recording medium M and then flows through the soft film Mb. In this process, recording signals are recorded on the recording medium M. Subsequently, the magnetic flux φa6 flowing through the soft film Mb flows into the return path layer 216 from the front end surface 216a thereof and further passes along the Y direction in the figure.

The magnetic flux φa6 flowing into the return path layer 216 flows in the Y direction in the figure together with the magnetic fluxes φa4 and φa5.

As described above, the main magnetic pole 110 and the return path layer 216 are connected to each other with the connection layer 225 provided therebetween. Hence, the magnetic fluxes φa4, φa5, and φa6 passing through the return path layer 216 flow into the main magnetic pole 110 through the connecting layer 225 and then pass through the main magnetic pole 110 in the direction opposite to the Y direction in the figure.

In the process described above, when flowing from the front end surface 110a of the main magnetic pole 110 into the return path layer 216, a portion of the magnetic flux φ2 also inevitably flows into the upper shield layer 106 as indicated by a chain line shown in FIG. 8, and as a result, a magnetic flux φm2 of a leakage magnetic field shown by a chain line is generated which flows in the Y direction in the figure. Since the length of the flow of the magnetic flux φm2 of the leakage magnetic field in the vertical direction, that is, a distance W1 from the main magnetic pole 110 to the upper shield layer 106, is larger than the length of the flow of the magnetic flux φ2 of the recording magnetic field in the vertical direction, that is, a distance W2 from the main magnetic pole 110 to the return path layer 216, when the magnetic flux φm2 of the leakage magnetic field flows from the main magnetic pole 110 into the upper shield layer 106, the recording fringing may occur, and recording properties may be degraded.

Herein, the distance “W1” indicates a distance from the center position of the main magnetic pole 110 in the thickness direction (Z direction in the figure) to the center position of the upper shield layer 106 in the thickness direction (Z direction in the figure). The distance “W2” indicates a distance from the center position of the main magnetic pole 110 in the thickness direction (Z direction in the figure) to the center position of the return path layer 216 in the thickness direction (Z direction in the figure).

In the magnetic head H2, when the magnetic field in a clockwise direction is generated around the first coil layers 108, and hence in the upper shield layer 106, a magnetic flux φc2 is generated which flows in the direction opposite to the Y direction in the figure. That is, in the upper shield layer 106 described above, the magnetic flux φm2 of the leakage magnetic field and the magnetic flux φc2 of the magnetic field in the direction opposite thereto are both generated. Accordingly, the magnetic flux φm2 of the leakage magnetic field flowing through the upper shield layer 106 is counteracted by the magnetic field φc2 generated in the upper shield layer 106. As a result, the flow of the magnetic flux φm2 of the leakage magnetic field through the upper shield layer 106 can be suppressed, and hence the recording fringing may be reduced.

In addition, as is the magnetic head H1 shown in FIG. 1, in the magnetic head H2 of the present invention, the intensity unbalance between the magnetic flux φm2 of the leakage magnetic field and the magnetic flux φc2 may not be significant, and hence the magnetic flux φm2 of the leakage magnetic field may be effectively counteracted. As a result, the recording fringing may be effectively suppressed.

By counteracting the magnetic flux φm2 of the leakage magnetic field in the upper shield layer 106, without increasing the coil resistance, the effective number of turns of the coil layer may be increased, and at the same time, the magnetic stability of the reading element 104 provided under the upper shield layer 106 may also be improved.

Furthermore, since the magnetic flux φm2 of the leakage magnetic field may be effectively counteracted by the two types of coil layers, that is, the coil layers 108 and 114, the whole magnetic head may be miniaturized.

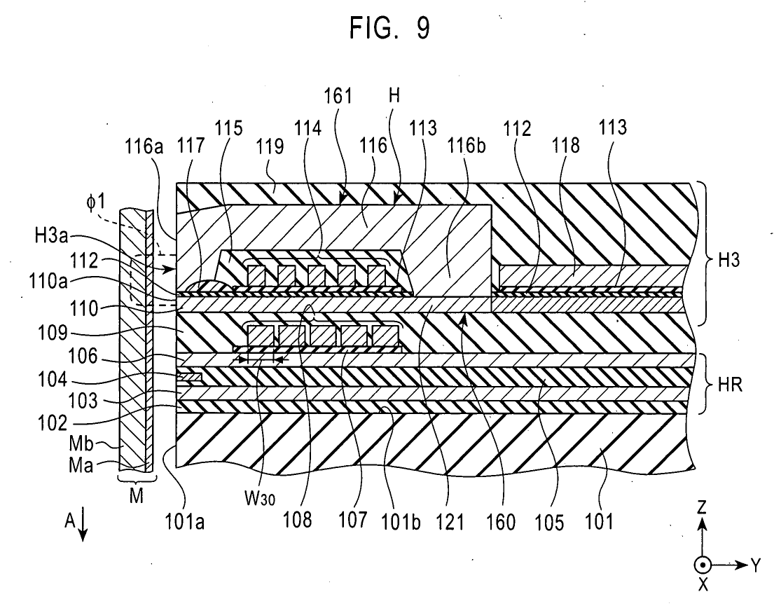

For the magnetic head H1 shown in FIG. 1, the width dimension W20 of the first coil layer 108 in the height direction (Y direction in the figure) and the width dimension W21 of the second coil layer 114 in the height direction (Y direction in the figure) may be formed equivalent to each other. However, according to a magnetic head H3 of a third embodiment shown in FIG. 9, a width dimension W30 of the first coil layer 108 in the height direction (Y direction in the figure) and the width dimension W21 of the second coil layer 114 in the height direction (Y direction in the figure) may be different from each other, and the width dimension W30 of the first coil layer 108 in the height direction (Y direction in the figure) may be formed larger than the width dimension W21 of the second coil layer 114 in the height direction (Y direction in the figure). In a perpendicular magnetic recording head, since a wider space may be secured at the height direction side (Y direction side in the figure) of the first coil layers 108, the first coil layer 108 may be formed to have a large width dimension W30.

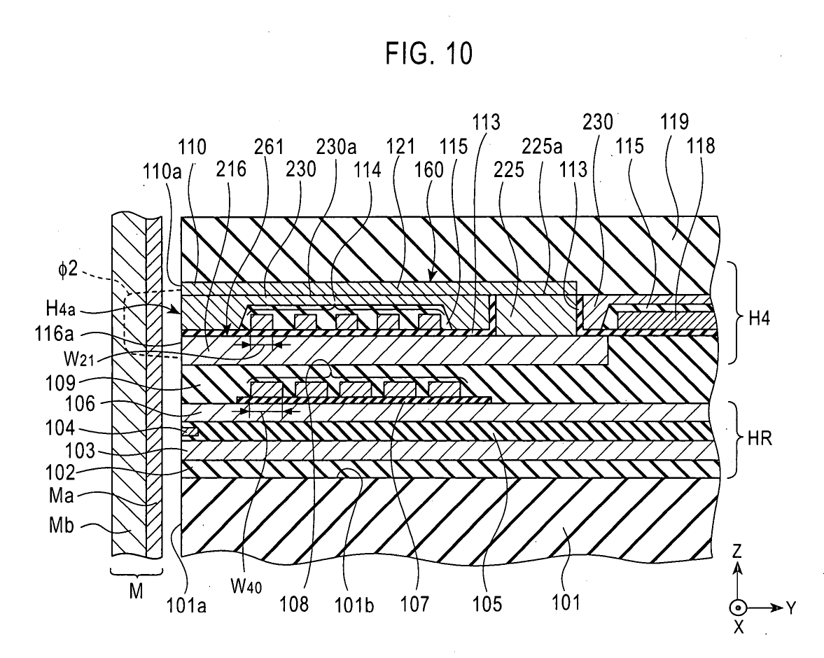

In the magnetic head H2 shown in FIG. 5, the width dimension W20 of the first coil layer 108 in the height direction (Y direction in the figure) and the width dimension W21 of the second coil layer 114 in the height direction (Y direction in the figure) are formed substantially equivalent to each other. However, in a magnetic head H4 of a fourth embodiment shown in FIG. 10, a width dimension W40 of the first coil layer 108 in the height direction (Y direction in the figure) and the width dimension W21 of the second coil layer 114 in the height direction (Y direction in the figure) may be different from each other, and the width dimension W40 of the first coil layer 108 in the height direction (Y direction in the figure) may be formed larger than the width dimension W21 of the second coil layer 114 in the height direction (Y direction in the figure). In a perpendicular magnetic recording head, a wider space may be secured at the height direction side (Y direction side in the figure) of the first coil layer 108, and the first coil layer 108 can be formed to have a large width dimension W40.

The magnetic head H4 shown in FIG. 10 has a similar structure as that of the magnetic head H1 shown in FIG. 1 except that the width dimension W40 and the width dimension W21 of the first coil layer 108 of the second coil layer 114, respectively, are different from each other.

In the magnetic heads H3 and H4 shown in FIGS. 9 and 10, respectively, since the cross-sectional area of the helical coil layer 120 may be increased, the electrical resistance of the helical coil layer 120 may be decreased, and heat generation of the magnetic head 3 or 4 may be suppressed. Accordingly, a so-called PTP (Pole Tip Protrusion) phenomenon can be effectively suppressed

Furthermore, in the magnetic heads H1 and H2 shown in FIGS. 1 and 5, respectively, and the magnetic heads H3 and H4 shown in FIGS. 9 and 10, respectively, when the dimensions of the first coil layer 108 and the second coil layer 114 or when the dimension of one of the above two coil layers is increased in the thickness direction (Z direction in the figure) so as to increase the cross-sectional area of the helical coil layer 120, the coil resistance may also be decreased. In the cases described above, the generation of heat can be suppressed, and hence the PTP described above may also be suppressed.

Although the present invention has been explained by way of the embodiments described above, it should be understood to the ordinary skilled person in the art that the invention is not limited to the embodiments, but rather that various changes or modifications thereof are possible without departing from the spirit of the invention. Accordingly, the scope of the invention shall be determined only by the appended claims and their equivalents.

1. A magnetic head assembly, comprising:
a slider;
a first magnetic portion having a main magnetic pole with a track width at a facing surface;
a second magnetic portion having a width dimension larger than the track width at the facing surface;
a helical coil wound around one of the first magnetic portion and the second magnetic portion;
the first and second magnetic portions being disposed over each other with a space therebetween, and being in magnetic communication at a position displaced in a height direction from a facing surface.

2. The magnetic head assembly according to claim 1, wherein a reading head is disposed in contact with the slider.

3. The magnetic head assembly according to claim 1, wherein the magnetic communication is a direct contact.

4. The magnetic head assembly according to claim 1, wherein the magnetic communication is an indirect contact.

5. The magnetic head assembly according to claim 1, wherein a gap layer is disposed between the first and second magnetic portions, and a gap determining layer is disposed on the gap layer at a distance displaced in the height direction from the facing surface.

6. The magnetic head assembly according to claim 5, wherein the gap determining layer is formed an organic material.

7. The magnetic head assembly according to claim 5, wherein the gap determining layer is formed an inorganic material.

8. The magnetic head assembly according to claim 1, wherein the helical coil is comprised of an upper coil layer and a lower coil layer having a different width than a width of the upper coil layer.

9. The magnetic head assembly according to claim 1, wherein the helical coil is comprised of an upper coil layer and a lower coil layer having a different thickness than a thickness of the upper coil layer.

10. The magnetic head assembly according to claim 1, wherein the first magnetic portion is located closer to the slider than the second magnetic portion

11. The magnetic head assembly according to claim 1, wherein the second magnetic-portion is located closer to the slider than the first magnetic portion.

12. A magnetic head assembly comprising;
a reading head;
a perpendicular magnetic recording head formed on the reading portion, the perpendicular magnetic recording head comprising:
a first magnetic portion which has a main magnetic pole with a track width at a facing surface;
a second magnetic portion having a width dimension larger than the track width, the first magnetic portion and the second magnetic portion being disposed one over the other with a space therebetween at a position above the reading portion, the first magnetic portion and the second magnetic portion in magnetic communication with each other at a position apart from the facing surface in a height direction;
a first coil layer formed between the reading portion and one magnetic portion of the first magnetic portion and the second magnetic portion, whichever is closer to the reading portion;
a second coil layer is formed between said one magnetic portion and the other magnetic portion disposed above said one magnetic portion, and
the first coil layer and the second coil layer electrically connected to each other so as to form a helical coil layer wound around said one magnetic portion.

13. The magnetic head assembly according to claim 12, wherein the magnetic communication is a direct contact.

14. The magnetic head assembly according to claim 12, wherein the magnetic communication is an indirect contact.

15. The magnetic head assembly according to claim 12, wherein the first coil layer has a cross-sectional area larger than that of the second coil layer.

16. The magnetic head assembly according to claim 12, wherein the first coil layer has a width dimension in the height direction larger than that of the second coil layer.

17. The magnetic head assembly according to claim 12, wherein the helical coil layer applies a recording magnetic field to said one magnetic portion, a magnetic path is formed in which a magnetic flux of the recording magnetic field flows through the first magnetic portion and the second magnetic portion, and a magnetic flux is generated around the first coil layer in a direction opposite to that of a magnetic flux, which flows into the reading portion, of a leakage magnetic field from the recording magnetic field, whereby the magnetic flux of the leakage magnetic field is counteracted by the magnetic flux in the direction opposite thereto.

18. The magnetic head assembly according to claim 12, wherein said one magnetic portion located closer to the reading portion is the first magnetic portion.

19. The magnetic head assembly according to claim 12, wherein said one magnetic portion located closer to the reading portion is the second magnetic portion.

20. A magnetic head assembly, comprising:
a slider;
means for forming a perpendicular magnetic field, the forming means having a track width at a facing surface;
means for receiving the perpendicular magnetic field at a facing surface, the receiving means having a greater dimension than the track width;
means for generating the perpendicular magnetic field;
means for canceling a leakage magnetic field.

21. A method of reducing fringing fields in a magnetic head assembly, the method comprising:
providing a slider;
disposing a first and a second magnetic portion above each other on the slider, the magnetic portions being separated by a gap layer and being magnetic communication at a position displaced in a height direction from a facing surface;
forming the first magnetic portion such that the first magnetic portion has a track width dimension at the facing surface, and the second magnetic portion such that the second magnetic portion has a width dimension greater than the track width dimension at the facing surface;
winding a helical coil around the first magnetic portion or the second magnetic portion.

22. The magnetic head assembly according to claim 21, wherein the magnetic communication is a direct contact.

23. The magnetic head assembly according to claim 21, wherein the magnetic communication is an indirect contact.

24. The method of claim 21, further comprising disposing a reading head between the slider and the first and second magnetic portions.

25. The method of claim 21, wherein the helical coil is comprised of an upper coil layer and a lower coil layer of different widths.

26. The magnetic head assembly according to claim 21, wherein the helical coil is comprised of an upper coil layer and a lower coil layer of different widths.
